(19) United States
(12) Patent Application Publication
(10) Pub. No.: US 2015/0168550 A1
(43) Pub. Date: Jun. 18, 2015

(54) METHOD AND APPARATUS FOR DRIVING ULTRASONIC SENSOR

(71) Applicants: Hyundai Motor Company, Seoul (KR); Kia Motors Corporation, Seoul (KR); Hyundai Mobis Co., Ltd., Seoul (KR)

(72) Inventors: Hyun Sang Kim, Hwaseong (KR); Sang Won Park, Suwon (KR)

(21) Appl. No.: 14/518,335

(22) Filed: Oct. 20, 2014

(30) Foreign Application Priority Data
Dec. 18, 2013 (KR) 10-2013-0158389

(51) Int. Cl. G01S 15/93; G01S 15/08

(52) U.S. Cl. CPC G01S 15/931; G01S 15/08; G01S 2015/932

(57) ABSTRACT

A method for driving ultrasonic sensors includes: transmitting a LIN communication message from an upper controller to ultrasonic sensors on a LIN network; receiving, by the ultrasonic sensors, the LIN communication message; confirming, by the ultrasonic sensors, a command of a protected identifier (PID) field of the LIN communication message; and if the command of the PID field is an object sensing command, measuring a distance from an object by allowing the ultrasonic sensors to directly emit an ultrasonic wave independent of values of the remaining fields of the LIN communication message.

### CROSS-REFERENCE TO RELATED APPLICATION

This application claims under 35 U.S.C. §119(a) the benefit of Korean Patent Application No. 10-2013-0158389 filed on Dec. 18, 2013, the entire contents of which are incorporated herein by reference.

### BACKGROUND

(a) Technical Field

The present invention relates to a method and an apparatus for driving an ultrasonic sensor, more particularly, a method and an apparatus for driving an ultrasonic sensor capable of reducing a response time and a measurement error even when implemented in a long distance parking assist system.

(b) Description of the Related Art

A rear sensing device for a vehicle using an ultrasonic sensor is an assist device which may be used when operating the vehicle in reverse and parking the vehicle.

Further, a parking assist system (PAS) uses the ultrasonic sensor to support automatic parking, and the like. Recently, technology for increasing a recognition distance of the ultrasonic sensor has been actively developed.

However, as the recognition distance is increased, there is a problem in that a reaction time may also be increased.

This is caused by a hardware configuration of the parking assist system for a vehicle, and FIG. 1 (RELATED ART) is a diagram illustrating a connection relationship between respective components of the parking assist system for a vehicle.

Ultrasonic sensors 20 which are mounted at a front and a rear of a vehicle, and a body control module (BCM) 10 of the vehicle, are connected to each other by LIN communication. As used herein, the term “LIN” (Local Interconnect Network) communication is a serial network protocol used for communication between components in a vehicle. For example, the body control module 10 and a display device 40 as a cluster can be connected to each other by controller area network (CAN) communication. A buzzer device 30 is driven in the display device 40 or the body control module 10. That is, when the ultrasonic sensors 20 which are mounted in the front and rear of the vehicle receive commands from the body control module 10 through LIN communication, the ultrasonic sensors 20 emit ultrasonic waves to sense objects and transmit distances from the sensed objects to the body control module 10 through LIN communication again. Further, the body control module 10 calculates an alarm step based on object distance information received from the ultrasonic sensors 20 and transmits the calculated alarm step to the display device 40, such as the cluster or an AV device, and uses the buzzer device 30 to issue an alarm to the user so as to perform an auxiliary role at the time of parking the vehicle.

FIG. 2 (RELATED ART) is a diagram illustrating a comparison result between a distance value required in a short distance parking assist system and a distance value required in a long distance parking assist system.

That is, since the existing short distance parking assist system is enough to sense only objects within 1.2 meters, the short distance parking assist system does not generate a large time difference during a process of transmitting the distance value measured by the ultrasonic sensor to an upper controller and generating an alarm based on the distance value.

However, when the long distance parking assist system needs to sense objects within about 2.5 meters and uses the existing communication method, the long distance parking assist system takes about 100 milliseconds (ms), which is as long as the case of transmitting the distance value measured by the ultrasonic sensor to the upper controller.

Therefore, the alarm is delayed at the time of operating the vehicle in reverse, and thus an accident is more likely to occur.

The above information disclosed in this Background section is only for enhancement of understanding of the background of the invention and therefore it may contain information that does not form the prior art that is already known in this country to a person of ordinary skill in the art.

### SUMMARY

The present invention provides a method and an apparatus for driving an ultrasonic sensor (e.g., an ultrasonic sensor included in a plurality of ultrasonic sensors in a vehicle) capable of improving a LIN communication scheduling and minimizing a response time and a measurement error of a long distance parking assist system.

In one aspect, the present invention provides a method for driving ultrasonic sensors, including: transmitting a LIN communication message from an upper controller to the ultrasonic sensors on a LIN network; receiving, by the ultrasonic sensors, the LIN communication message; confirming, by the ultrasonic sensors, a command of a protected identifier (PID) field of the LIN communication message; and if the command of the PID field is an object sensing command, measuring a distance from an object by allowing the ultrasonic sensors to directly emit an ultrasonic wave independent of values of the remaining fields of the LIN communication message.

In an exemplary embodiment, the method for driving an ultrasonic sensor may further include: after receiving the LIN communication message, performing synchronization when the ultrasonic sensors receive the PID field.

In another exemplary embodiment, the upper controller may be a body control module (BCM), an electric control unit (ECU) of a smart parking assist system (SPAS), or a control unit of a parking assist apparatus.

In still another exemplary embodiment, the method for driving an ultrasonic sensor may be implemented in a parking assist system of a vehicle.

In another aspect, the present invention provides an apparatus for driving a plurality of ultrasonic sensors, including: the ultrasonic sensors being mounted at a front and a rear of a vehicle and each configured to generate an ultrasonic wave; an upper controller configured to allow the ultrasonic sensor to send out a LIN communication message including an object sensing command when a parking assist system of the vehicle is operated; and a driving unit configured to decode the LIN communication message sent out by the upper controller and if a command of a PID field of the LIN communication message is an object sensing command, issue an ultrasonic wave generation command to the ultrasonic sensor even though values of the remaining fields of the LIN communication message are not confirmed.

As set forth above, according to the method and apparatus for driving an ultrasonic sensor according to the exemplary embodiments of the present invention, since the ultrasonic sensors may directly perform the object sensing operation even during the LIN communication, it is possible to shorten the object sensing time in the long distance parking assist system. Therefore, it is possible to secure impact stability on short distance obstacles at the time of parking the vehicle.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 (RELATED ART) is a diagram illustrating a connection relationship between respective components of a parking assist system of a vehicle;

FIG. 2 (RELATED ART) is a diagram illustrating a comparison result between a distance value required in a short distance parking assist system and a distance value required in a long distance parking assist system;

FIG. 3 is a diagram illustrating a comparison result between a process of performing LIN communication and an operation of an ultrasonic sensor;

FIG. 4 is a diagram illustrating a LIN protocol according to an exemplary embodiment of the present invention;

FIG. 5 is a diagram illustrating an error result at the time of measuring a distance by the existing parking assist system; and

FIG. 6 is a diagram illustrating a result of errors at the time of measuring a distance by a parking assist system to which a method for driving an ultrasonic sensor according to the exemplary embodiment of the present invention is applied.

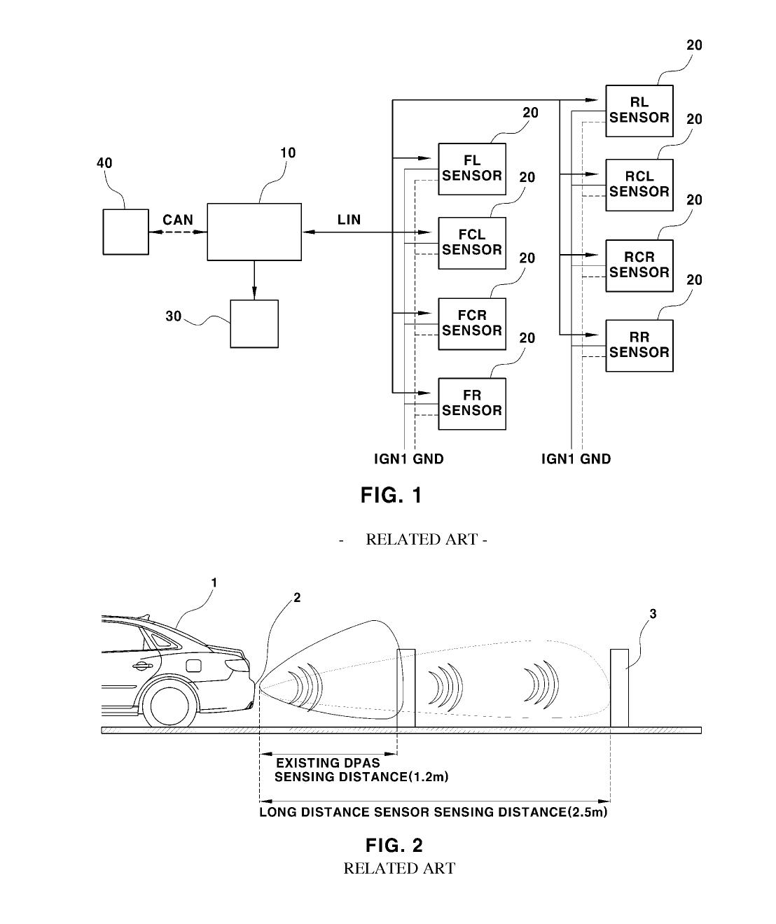

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter, exemplary embodiments of the present invention will be described in detail with reference to the accompanying drawings. Since the present invention may be variously modified and have several exemplary embodiments, specific exemplary embodiments will be shown in the accompanying drawings and be described in detail. However, it is to be understood that the present invention is not limited to the specific exemplary embodiments, but includes all modifications, equivalents, and substitutions included in the spirit and the scope of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “LIN” (Local Interconnect Network) communication is a serial network protocol used for communication between components in a vehicle. In particular, LIN communication is a method for performing communication by previously defining transmission and reception of frames each time, and transmitting and receiving the defined frames in the defined time. Further, LIN communication is largely configured of a master request frame and a slave response frame.

In the method and apparatus for driving an ultrasonic sensor (e.g., each ultrasonic sensor of a plurality of ultrasonic sensors provided in a vehicle) according to the exemplary embodiment of the present invention, the ultrasonic sensor and an upper controller are connected to each other by LIN communication.

Since the ultrasonic sensor and the upper controller, that is, a body control module 10, are connected to each other by a LIN bus, the method and apparatus for driving the ultrasonic sensor according to the exemplary embodiment of the present invention may save the number and weight of wires; however, since only one bus is used, the method and apparatus for driving the ultrasonic sensor preferably are required to use scheduling defined for transmission and reception.

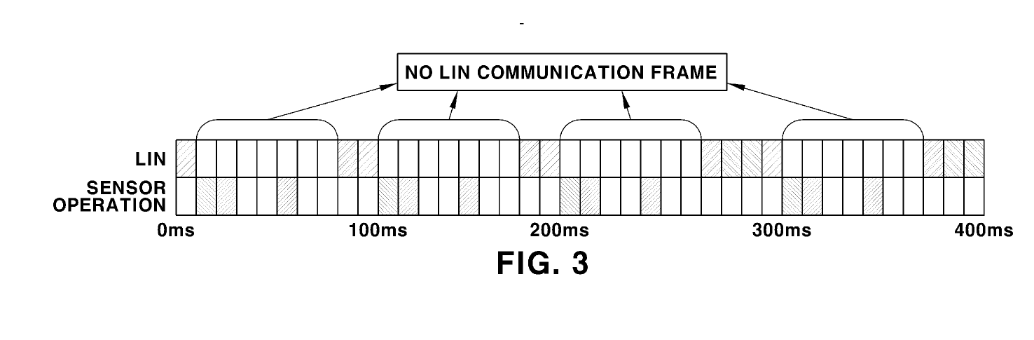

FIG. 3 is a diagram illustrating a comparison result between a process of performing LIN communication and an operation of the ultrasonic sensor 20.

As can be appreciated from FIG. 3, a transmission time of each command is approximately 10 milliseconds (ms).

Further, since LIN communication is operated depending on the defined scheduling, there is spare time when any work is not done in the LIN communication line for about 70 milliseconds (ms) within which the ultrasonic sensor 20 receives a master command from the upper controller and then processes the received master command.

Therefore, in the case in which the ultrasonic sensors 20 are sequentially driven, after the ultrasonic sensor first receiving an ultrasonic wave measurement command measures a distance, a temporal error may occur when the next and subsequent ultrasonic sensors measure a distance. Further, the larger the error range of an oscillator, the larger the error becomes.

Therefore, the method and apparatus for driving an ultrasonic sensor according to the exemplary embodiment of the present invention propose a protocol to measure a distance using the ultrasonic sensor the moment that a LIN communication message is received and to transmit the measured value to the upper controller again.

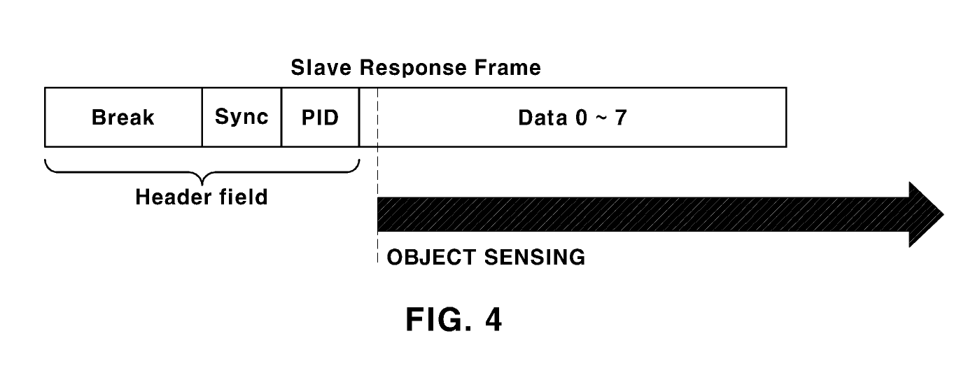

FIG. 4 is a diagram illustrating a LIN protocol according to an exemplary embodiment of the present invention.

The method for driving an ultrasonic sensor according to the exemplary embodiment of the present invention may receive the LIN message and directly sense an object when a command of a PID field of a header field is an object sensing command, even though data within all frames are not received.

Therefore, the existing method requires time to receive a data field, while the method and apparatus for driving an ultrasonic sensor according to the exemplary embodiment of the present invention may measure a distance from an object while shortening time corresponding to the time to receive the data field.

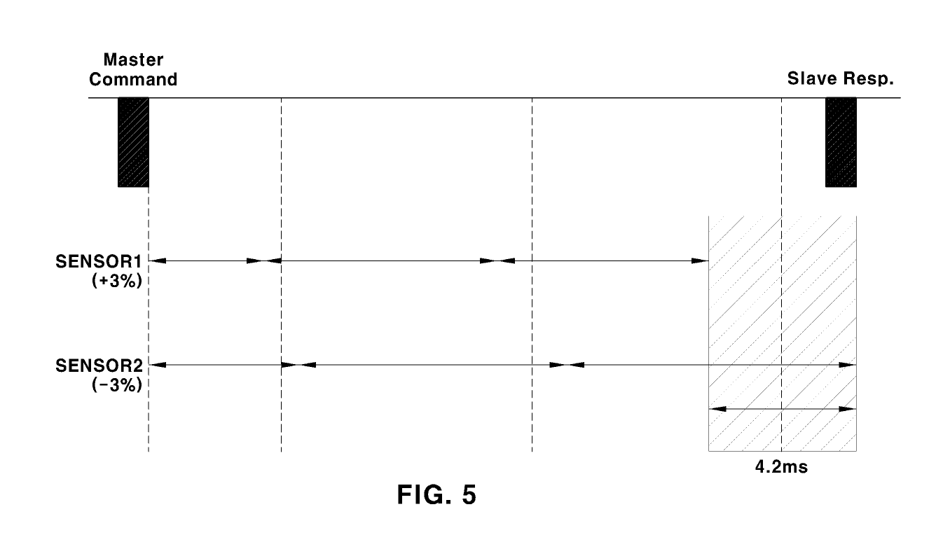

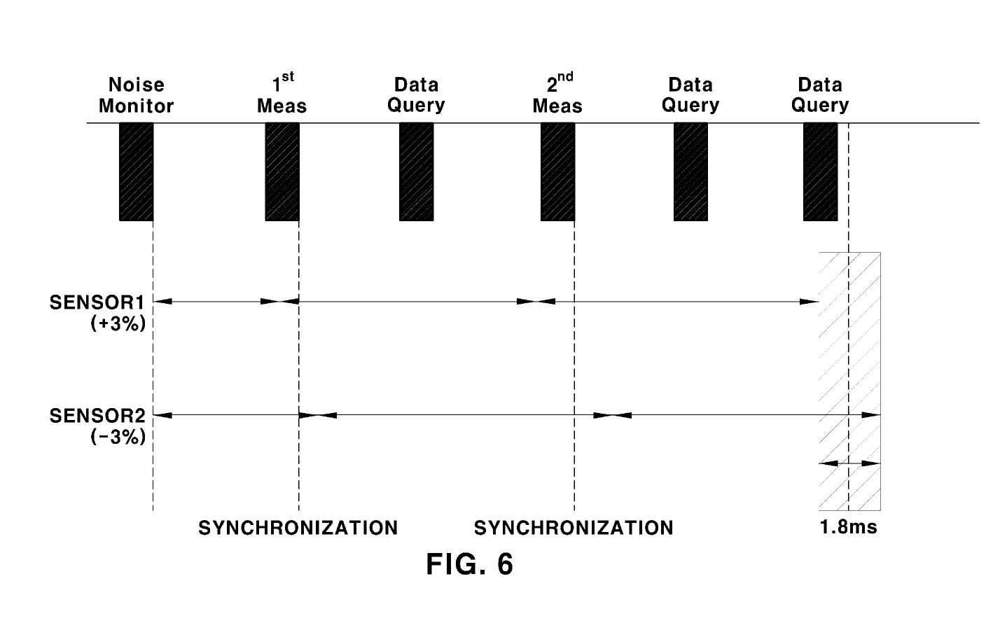

FIGS. 5 and 6 are diagrams illustrating a comparison result of errors at the time of measuring a distance by the existing parking assist apparatus and a parking assist apparatus to which the method for driving an ultrasonic sensor according to the exemplary embodiment of the present invention is applied.

It may be confirmed from FIG. 5 that in the existing parking assist apparatus, errors are continuously accumulated in a continuous measurement between sensor 1 having a + error and sensor 2 having a − error and thus an error as much as about 4.2 milliseconds occurs between the two sensors in the final measurement.

However, since the parking assist apparatus to which the method for driving an ultrasonic sensor according to the exemplary embodiment of the present invention of FIG. 6 is applied performs a synchronization process simultaneously with receiving an ID through the LIN communication, even though one sensor has the (+) error and the other sensor has the (−) error, it may be confirmed that the error between both sensors is not accumulated and finally, only an error of about 1.8 milliseconds is present.

Therefore, even though the existing hardware system is used in the long distance parking assist apparatus, the possibility of accident caused by a delayed alarm due to the measurement of the distance from the targeted object may be reduced by LIN communication.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for driving a plurality of ultrasonic sensors, comprising:
transmitting a LIN communication message from an upper controller to the ultrasonic sensors on a LIN network;
receiving, by the ultrasonic sensors, the LIN communication message;
confirming, by the ultrasonic sensors, a command of a protected identifier (PID) field of the LIN communication message; and
if the command of the PID field is an object sensing command, measuring a distance from an object by allowing the ultrasonic sensors to directly emit an ultrasonic wave independent of values of the remaining fields of the LIN communication message.

2. The method of claim 1, further comprising:
after the step of receiving the LIN communication message, performing synchronization when the ultrasonic sensors receive the PID field.

3. The method of claim 2, wherein the upper controller is a body control module (BCM), an electric control unit (ECU) of a smart parking assist system (SPAS), or a control unit of a parking assist apparatus.

4. The method of claim 2, wherein the method is implemented in a parking assist system of a vehicle.

5. The method of claim 1, wherein the upper controller is a body control module (B CM), an electric control unit (ECU) of a smart parking assist system (SPAS), or a control unit of a parking assist apparatus.

6. The method of claim 1, wherein the method is implemented in a parking assist system of a vehicle.

7. An apparatus for driving a plurality of ultrasonic sensors, comprising:
the ultrasonic sensors being mounted at a front and a rear of a vehicle and each configured to generate an ultrasonic wave;
an upper controller configured to allow each of the ultrasonic sensors to send out a LIN communication message including an object sensing command when a parking assist system of the vehicle is operated; and
a driving unit configured to decode the LIN communication message sent out by the upper controller, and if a command of a PID field of the LIN communication message is an object sensing command, issue an ultrasonic wave generation command to each of the ultrasonic sensors even though values of the remaining fields of the LIN communication message are not confirmed.
